(19) United States
(12) Patent Application Publication
(10) Pub. No.: US 2008/0191517 A1
(43) Pub. Date: Aug. 14, 2008

(54) Sealing, Trimming And Guide Strips

(75) Inventor: Bernhard Kreye, Wunstorf (DE)

Correspondence Address: WORKMAN NYDEGGER, 60 EAST SOUTH TEMPLE, 1000 EAGLE GATE TOWER, SALT LAKE CITY, UT, 84111, US

(73) Assignee: GDX NORTH AMERICA INC., Dover, DE (US)

(21) Appl. No.: 11/577,523

(22) PCT Filed: Sep. 26, 2005
(86) PCT No.: PCT/DE2005/001713

§ 371 Date: Nov. 12, 2007

(30) Foreign Application Priority Data
Oct. 20, 2004 (GB) 0423321.9

(51) Int. Cl. B60R 13/06

(52) U.S. Cl. 296/201

(57) ABSTRACT

The invention relates to a sealing, trimming or guide strip (15) for the window of a motor vehicle, comprising a continuous loop arranged around the fixed triangular window (11) of the vehicle and an additional loop arranged around the displaceable main window (9) of the rear door of the vehicle. This seal comprises an extruded section (19) in order to maintain the pleasant optical appearance of the vehicle exterior. A section of the extruded material (19) is replaced by formed material that is formed on the fixed triangular window (11). The formed material comprises a recess in order to engage the extruded part and thereby connecting the extruded part mechanically to the formed material and the fixed triangular window (11).

The invention relates to sealing, trimming or guide strips.

Strips which form the basis of the invention, which is described in more detail hereinbelow, merely by way of example, are used for sealing, trimming and guiding window panels in vehicle-body manufacturing.

The invention provides an arrangement which is intended for mounting a sealing, trimming or guide strip in relation to a window panel and has a part which is fitted on the window panel and has means for connecting the strip mechanically to the part.

The invention also provides the method as claimed in claim 37.

Sealing, trimming or guide strips which are intended for vehicles and form the basis of the invention are described hereinbelow, merely by way of example, with reference to the accompanying schematic drawings, in which:

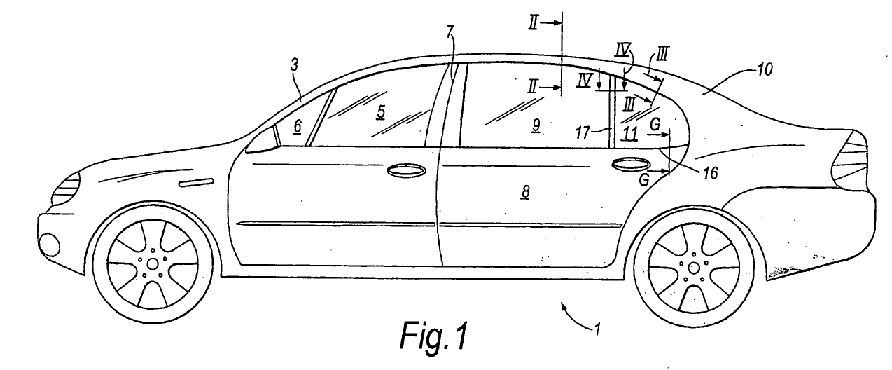

FIG. 1 shows a side view of a motor vehicle on which are fitted strips of this type according to a first configuration of the invention;

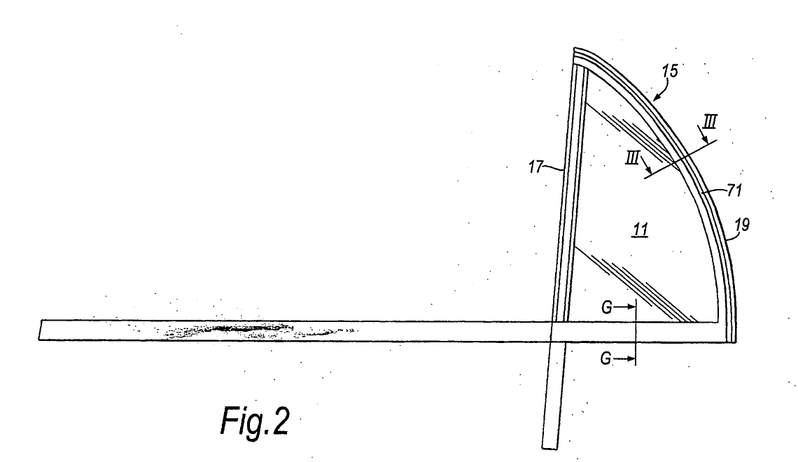

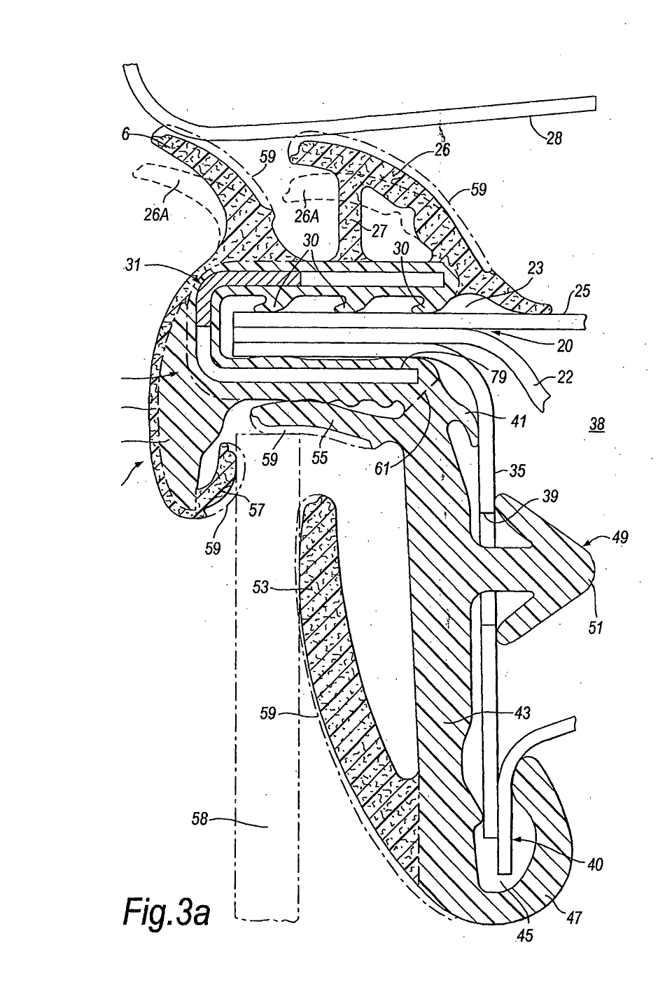

FIG. 2 shows a side view of one of the strips;

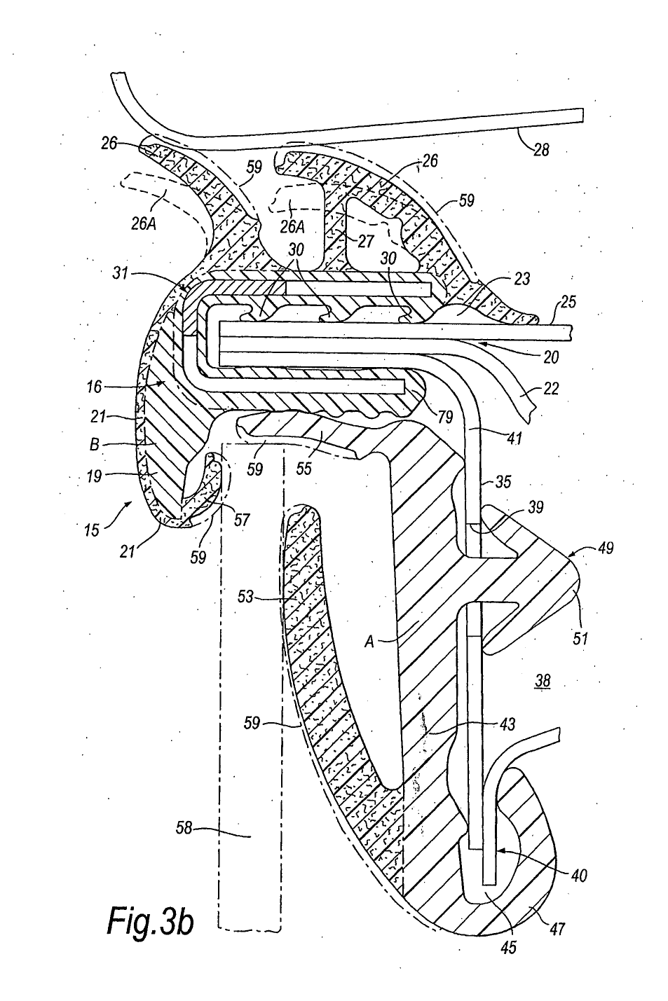

FIG. 3a shows a cross-sectional view along line II-II from FIG. 1;

FIG. 3b shows a cross-sectional view which is taken along line II-II from FIG. 1 and shows a modification;

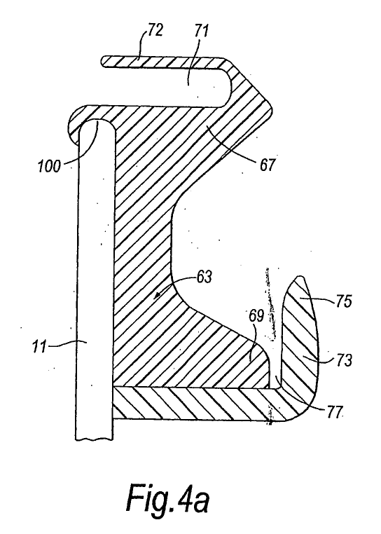

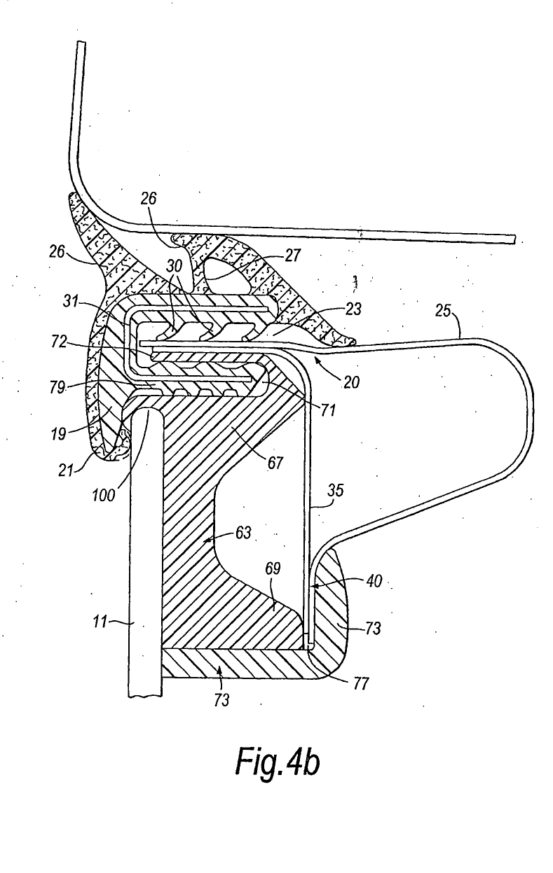

FIG. 4a shows a cross-sectional view along line III-III from FIG. 1 without any panel-guide part;

FIG. 4b shows a cross-sectional view along line III-III from FIG. 1 with the panel guide;

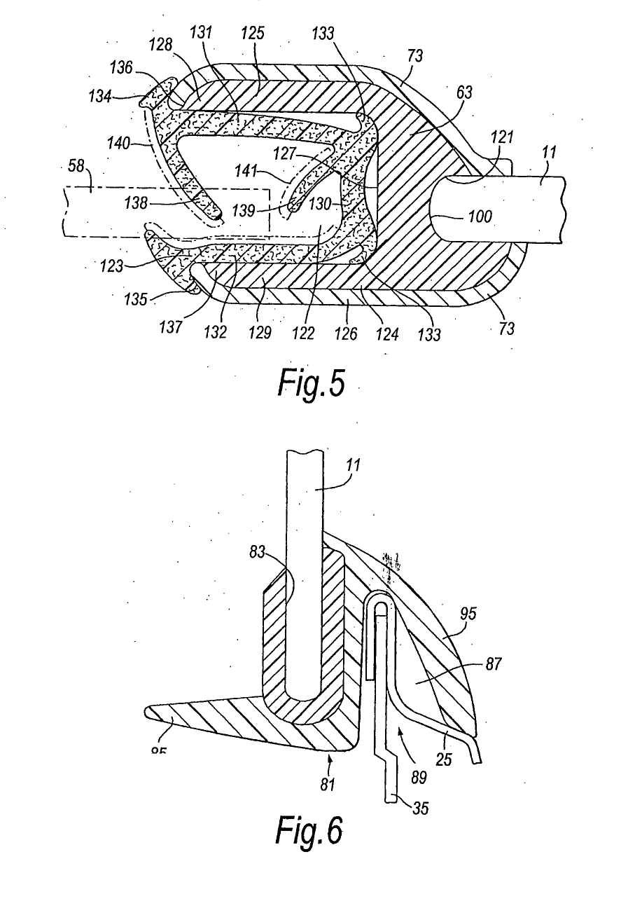

FIG. 5 shows a cross-sectional view along line IV-IV from FIG. 1;

FIG. 6 shows a cross-sectional view along line G-G from FIG. 1;

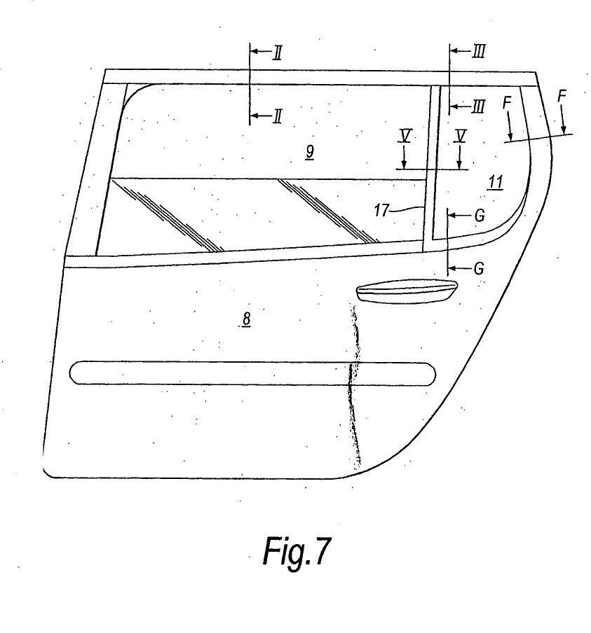

FIG. 7 shows a side view of the rear door of a motor vehicle with a sealing-strip arrangement according to a second configuration of the invention;

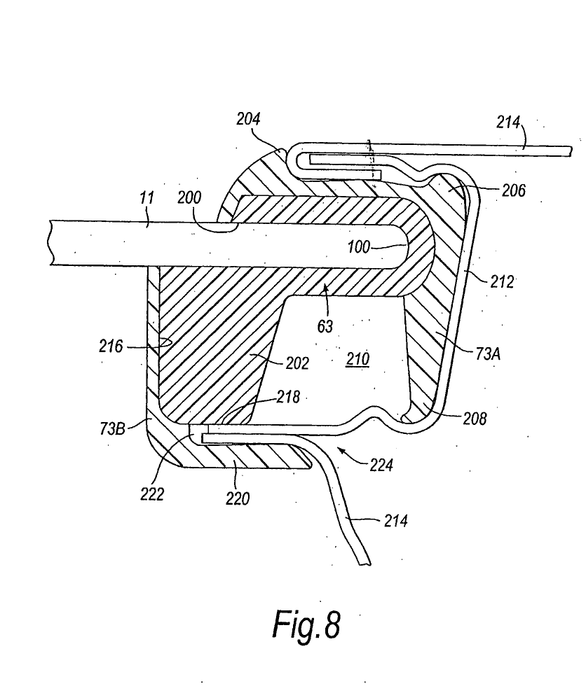

FIG. 8 shows a cross-sectional view along line F-F from FIG. 7; and

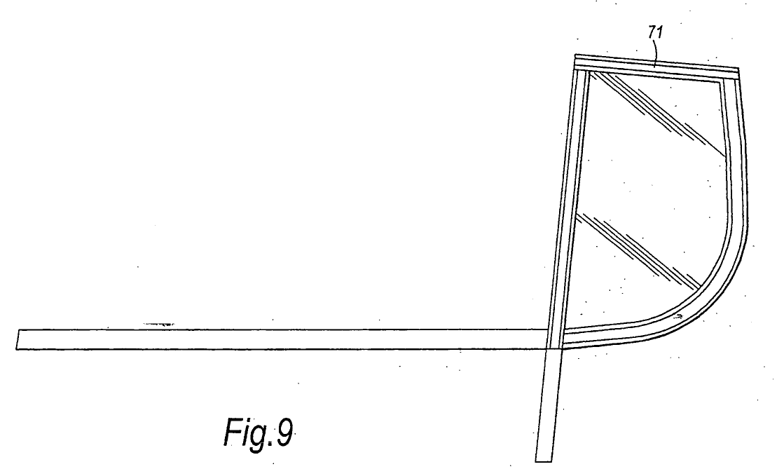

FIG. 9 shows a side view of the sealing strip of the door from FIG. 7.

The side view of the motor vehicle 1 in FIG. 1 shows the A-pillar 3 of the vehicle, where the front side window 5 (or the front quarter-window panel 6, if one is provided) runs alongside the windshield (not shown). The B-pillar 7 is located between the front side window 5 and the main side window 9 at the rear. For vehicles with rear doors 8, it is typical for them to have, in addition to the main window 9 (which normally has a glass panel which can be raised and lowered), a smaller quarter-window panel 11. The smaller quarter-window panel 11 generally has a fixed glass panel. The C-pillar 10 of the vehicle runs downward along the rear side of the frame of the opening for the door 8.

The present invention relates primarily to the design and production of a sealing, trimming or guide strip for the frame of the rear main window 9 and of the quarter-window panel 11.

FIG. 2 shows part of a sealing, trimming or guide strip for mounting in the frame of the main window 9 and of the quarter-window panel 11. The depicted part of the strip, which is shown in general terms at 15, has a loop portion, which runs around the quarter-window panel 11, and a center-line portion, which runs along the underside of the main window 9, and a crossmember 17. The strip has a continuously extruded part running continuously around the top and rear sides of the quarter-window panel 11 and also along the top side of the main window. The continuously extruded part 19 provides a pleasing, joint-free outer appearance. The design of the strip 15 will be understood more specifically from the following detailed description of the cross sections II-II, III-III, IV-IV and G-G.

FIG. 3a shows a cross section through the strip at the region above the rear main window 9 (along line II-II from FIG. 1). The continuously extruded part 19 forms the outer strip end surface which can be seen, at least in part, from outside the vehicle. The continuously extruded part 19 is formed with regions 21 which are made of relatively soft material—as is shown by relatively closely spaced-apart cross-hatched lines. The inside of the strip 15 defines a channel 23 which encloses a flange 20 which is formed by metal sheets 22, 25, 35 of the rear door 8 and forms the frame for the window 9 and the quarter-window panel 11. The uppermost outer surface of the channel 23 bears integrally formed elastically deformable lips 26 which press against a body sheet 28 defining the opening for the rear door 8. The lips 26 can be deformed into a position 26A (illustrated by dashed lines) when the door 8 is closed. A crosspiece 27, which forms part of the strip 15, runs between the inner lip 26 and the uppermost outer surface of the channel 23. The vehicle body 28 runs along the top of the door opening essentially parallel to the roof of the vehicle 1.

A channel-like reinforcing support 31 is embedded integrally in the continuously extruded part 19 during extrusion. The reinforcing support 31 may be made of metal and provided with recesses or slots in order to improve its flexibility. For example, it may comprise U-shaped elements which are arranged one beside the other in order to define a channel, the elements either being connected integrally to one another by short flexible connecting members or perhaps being completely separate from one another. Looped wire may be used instead. It is also possible to use other types of support.

The continuously extruded part 19 is extruded in order to provide integrally formed elastically deformable lips 30 in the channel 23 which help to retain the strip securely in position on the flange 20.

The metal sheets 22, 25, 35 forming the frame of the window are spot-welded (or fitted together in some other way) in order to form the flange 20, then diverge from one another in order to form a cavity 38, and the metal sheets 25 and 35 then come together again in order to form a further flange 40, at which they are spot-welded (or fitted together by some other means).

Extending from the bottom side of the channel 23 (and extruded integrally therewith) is an extension 43, which defines a further channel 45 by way of an integrally extruded lip 47. The channel 45 accommodates the flange 40 and encloses it elastically. The extension 43, furthermore, is clamped on the window frame with the aid of an elastically deformable protrusion 49 with an enlarged head part 51, which is forced through an opening 39 in the metal sheet 35 and into the cavity 38. Once it has been guided through the opening 39, the enlarged head part 51 springs back and presses against the metal sheet 35 around the peripheries of the opening 39.

The continuously extruded part 19 of the strip 15 has an additional lip 41, which butts against the metal sheet 35.

The extension 43 bears a lip 53 which runs in the direction of a lip 57 which is integrally formed on the extruded material defining the channel 23. The lips 53 and 57 together form a channel or recess for accommodating the periphery of the panel 58 of the window 9. The lip 53 is in contact with the inside of the window panel 58 when the window has been closed. The lip 57 is in contact with the outside of the window panel 58. A further lip 55 butts against the top periphery of the window panel 58. Each of the lips 53, 55 and 57 may be provided with a coating made of flocked material 59 at the point at which they butt against the glass 9. The lip 53 cannot be seen from outside the vehicle. Its top part is concealed by the continuously extruded part 19 and may further be concealed by black tinting, which is applied to the top part of the window panel 58, when the window is closed.

FIG. 3b shows an alternative arrangement to that of FIG. 3a, the extension 43 and the associated parts being designed as an extruded element A which is separate from the extruded element B, in which case the latter forms the channel 23 and associated parts.

The structure of the strip 15 changes as the strip runs from the main window opening 9 to the quarter-window panel 11 on the far side of the crossmember 17. On the far side of the crossmember 17 and around the top and rear peripheries of the quarter-window panel 11, and generally parallel to the C-pillar 10, the strip 15 is in the form which is shown in FIG. 4b. This form (referred to herein as the “panel-guide part”) is produced by means of the strip structure which is shown in FIG. 3a being severed along the line 61. The material beneath the line 61 in FIG. 3a is removed and can be disposed of. Of course, if the strip 15 is in the form which is shown in FIG. 3b, it would not be necessary to cut along the line 61 in order to remove material beneath this line, because the part A is separate from the part B—in which case the latter forms the “panel-guide part”.

As is shown in FIG. 4a, a non-reinforced piece of harder material 63 is formed onto the inner planar surface of the quarter-window panel 11, around the periphery thereof, and runs generally parallel to the C-pillar 10. The harder material 63 runs around the periphery 100 of the quarter-window panel 11 and a relatively short distance along the outer planar surface of the quarter-window panel 11. The harder material 63 has a greater thickness at the end 67, which runs over the periphery 100 of the quarter-window panel 11, and also at its opposite end 69 (following the portion of lesser thickness). A U-shaped groove 71 is formed in the harder material 63 (during the forming process) at the end 67, this groove running generally perpendicularly to the planar surface of the quarter-window panel 11 and forming a distal wall 72. Once the harder material 63 has been formed onto the quarter-window panel 11, a relatively soft material 73 is formed onto the end 69 of the harder material 63 and onto the quarter-window panel 11. The relatively soft material is L-shaped and has a single-piece base portion 75, which is spaced apart (by interspace 77) from the harder material 69. The softer material 73 may have an attractive appearance.

As is shown in FIG. 4b, the interspace 77 accommodates the flange 40 formed by the metal sheets 25, 35 of the door 8. The flange 20 of the door frame 8 overlaps the distal wall 72 of the harder material 63 and butts against the same, and runs parallel to the groove 71.

The quarter-window panel and the harder and softer parts 63, 73 fitted thereon are then connected to the panel-guide part (or part B) of the strip 15 by the leg 79 of the strip 15 being plugged into the groove 71. At the same time, the flange 20 is accommodated in the channel 23 of the strip 15 together with the distal wall 72 of the harder material 63. The strip 15 is connected securely to the quarter-window panel, the harder material 63 and the softer material 73 in that the elasticity of the harder material 73 causes the leg 79 of the strip 15 to be clamped firmly and the lips 30 in the channel 23 of the strip 15 press against the flange 20. The harder material 63 is the same as the harder material 63 which is shown in FIGS. 3a and 3b and is thus formed integrally on the quarter-window panel 11. The softer material 73 is the same as the softer material 73 which is shown in FIGS. 3a and 3b and is thus formed in a single piece and formed onto the harder material 63.

FIG. 5 shows the design of the strip 15 on the crossmember 17 (cross section IV-IV). A non-reinforced piece of the harder material 63 is formed around the periphery 100 of the second quarter-window panel 11. The harder material 63 thus forms a first channel 121, which accommodates this periphery 100. During forming, the harder material 63 is also provided with a second channel 122, which opens in a direction opposed to the first channel 121 and contains a separate seal 123, which will be described in detail hereinbelow. Once the harder material 63 has been formed around the quarter-window panel 11, the softer material 73 is formed onto the outer surfaces of the harder material 63. The harder material 63 and the softer material 73, once again, are the same as the identically designated parts mentioned above, and are thus formed in one piece and at the same time.

The second channel 122 is generally U-shaped with a base 127 and a first and a second projecting extension 128, 129. The seal 123, which is contained in the second channel 122, serves for engaging the movable window panel 58. The seal 123 is made of a flexible material and has a generally U-shaped cross section with a base 130 and a first and a second extension 131, 132. A pair of lips 133 project from respective opposite ends of the base 130 and butt against the second channel 122, in order to retain the seal 123 in the second channel 122.

The first extension 131 and the second extension 132 terminate, at their free ends, in respective flanges 134, 135, which cover the respective ends 136, 137 of the extensions 128, 129 of the second channel 122. The first extension 131 of the seal 123 bears two inwardly projecting lips 138, 139. The first lip 138 is located in the direction of the free end of the first extension 131 and the second lip 139 is located at the point of connection between the first extension 131 and the base 130. The two lips 138, 139 have flocked surfaces 140, 141 for butting against the periphery of the window panel 58.

The extruded part 19 terminates where it comes into contact with the center line of the door, and the strip 15 is in the form 81, which is shown in FIG. 6 (cross section G-G), along the bottom end of the quarter-window panel 11. This strip portion 81 is made of harder and softer formed material 63, 73 and defines a glass-accommodating channel 83. The harder material 63 is the same as the harder material 63 which is shown in FIGS. 3a, 3b, 4a and 4b and is thus formed integrally on the quarter-window panel 11. The softer material 73 is the same as the softer material 73 which is shown in FIGS. 3a, 3b, 4a and 4b and is thus formed in one piece and formed onto the harder material 63.

The softer material forms a lip 85 for sealing against part of the rear door 8 (not depicted) and also forms a V-shaped channel 87 for accommodating a flange 89 of the rear door 8, this flange comprising the metal sheets 25 and 35. The distal wall 95 of the channel butts against the metal sheet 25 and conceals the flange 89 from view, as a result of which the appearance of the rear door 8 is improved and, in addition, the degree to which moisture penetrates into the interior of the rear door 8 is also reduced.

FIGS. 7, 8 and 9 show a second configuration of the invention. The door 8 is configured in a different way, the top part of the frame being generally linear above the quarter-window panel 11. In this configuration, the panel-guide part runs along only that part of the door 8 which runs generally parallel to the roof; the panel-guide part does not run parallel to the C-pillar. In the second configuration, the cross sections along lines II-II, III-III, IV-IV and G-G are identical to the similarly designated cross sections described in the first configuration. The cross section along line F-F from FIG. 6 (through that part of the door which runs generally parallel to the C-pillar 10) is different and is shown in FIG. 8.

In FIG. 8, harder material 63 is formed onto the quarter-window panel 11 so as to cover the periphery 100 thereof, and to form a generally U-shaped channel 200. From the bottom side of this channel, a trapezoidal protrusion 202 extends integrally from the harder material 63, the protrusion tapering in the direction away from the channel 200. Two pieces of softer material 73A, 73B are formed onto the harder material 63. The first piece of softer material 73A runs over that portion of the harder material 63 which forms the top part of the channel 200 and covers the periphery 100 of the panel 11. The part 73A has an integrally formed abutment protrusion 204, an integrally formed smaller lip 206 and an integrally formed larger lip 208 for butting against a generally U-shaped channel 210, which is formed by the metal door sheets 212 and 214.

The second part of the softer material 73B runs over the surface 216 of the protrusion 202, this surface being furthest away from the periphery 100, and the surface 218 of the protrusion 202, this surface being furthest away from the planar surface of the glass panel 11. The softer material 73B is formed onto the protrusion 202 only along approximately a third of the surface 218. Along the remaining two thirds of the surface 218, and beyond, the part 73B forms a wall 220 which is spaced apart from the surface 218 and forms a channel 222, which accommodates a flange 224 (formed by the metal sheets 212 and 214 and covering a leg of the U-shaped channel 210). The quarter-window panel 11 is fastened on the harder material 63 and the part made of softer material 73A and 73B by forming. The quarter-window panel 11 and the harder/softer material 63, 73A, 73B are fastened on the metal sheets 212 and 214 of the door 8 by the friction fitting of the channel 222 and of the abutment protrusion 204 and of the lips 206 and 208.

As is shown in FIG. 9, in the second configuration, the groove 71, which accommodates the panel-guide part, runs along only that surface of the quarter-window panel 11 which runs generally parallel to the vehicle roof (and not generally parallel to the C-column 10).

The quarter-window panel is supplied to a customer with the harder material 63 and softer material 73, 73A, 73B already formed thereon. The quarter-window panel 11, the center-line part of the strip 15 and the panel-guide part of the strip 15 may all be supplied separately (i.e. not connected to one another) to a customer. These parts would then be assembled by the customer.

As an alternative, the center-line part of the sealing strip 15 may be supplied to a customer in a state in which it has already been formed onto the material 63, 73A, 73B of the quarter-window panel 11, the panel guide being supplied separately. These parts would then be assembled by the customer.

As an alternative, it would further be possible for the quarter-window panel 11 to be supplied to a customer as a unit together with the center-line part formed thereon and the panel guide fastened on the quarter-window panel 11.

In each of the configurations described above with reference to the drawings, the harder material 63 preferably has a Shore hardness D of 40 and may be made, for example, from polypropylene. The softer material 73 has a Shore hardness A of 60 and may be made of a thermoplastic material.

It may be gathered that the strip 15 need not necessarily be arranged in the manner described above. It is possible to provide a greater or lesser number of lips, and a greater or lesser number of recesses, than described above. The number of lips and recesses is usually determined by the configuration of the door with which the strip 15 is to cooperate. The quarter-window panel 11 may be fastened on the harder material 63 and/or the softer material 73 by an adhesive or some other bonding material (not shown). The adhesive (or other bonding material) may be applied to the glass prior to the operation of forming the harder material 63 and/or softer material 73, for bonding to this material once it is formed. As an alternative, the adhesive may be applied to the material and/or the glass once the material has been formed, in order for the material to be fastened on the glass. It is also possible, as an alternative, for the glass to be fastened on the material by a bond being formed between the material and the glass or by friction fitting between the material and the glass.

Although, in a number of configurations, the softer material may be formed over the entire exposed outer surface of the harder material, this is optional. It is possible for just some of the exposed visible surface of the harder material to be covered in this way.

The sealing, trimming or guide strip of the invention can also be applied to the front side window of a vehicle.

1. An arrangement which is intended for mounting a sealing, trimming or guide strip in relation to a window panel and has a part which is fitted on the window panel and has means for connecting the strip mechanically to the part.

2. The arrangement as claimed in claim 1, in which the part has an accommodating structure for connecting to a plug-in structure of the strip.

3. The arrangement as claimed in claim 2, in which the accommodating structure has a recess or groove for connecting to the plug-in structure of the strip.

4. The arrangement as claimed in claim 1, in which the part is provided by forming.

5. The arrangement as claimed in claim 4, in which the part is formed onto the window panel.

6. The arrangement as claimed in claim 1, in which the strip is formed by extrusion.

7. The arrangement as claimed in claim 6, in which a portion of the extruded material of the strip which runs only along part of the length of the latter is removed and replaced by the part.

8. The arrangement as claimed in claim 1, in which the part is lengthened in order to form a closed loop.

9. The arrangement as claimed in claim 7, in which the length of the extruded material on the far side of said portion of this material runs from the closed loop.

10. The arrangement as claimed in claim 1, in which the strip has a plurality of integrally formed structures for fastening the extruded part on the frame of the window.

11. The arrangement as claimed in claim 7, in which the extruded material has a channel for accommodating a flange of a window frame, the channel being retained as part of the strip following the removal of said portion of the extruded material.

12. The arrangement as claimed in claim 11, which has a rigid reinforcing support which is embedded in the extruded material in the region which corresponds to the channel.

13. The arrangement as claimed in claim 12, in which the embedded rigid element runs in the direction of the channel in order to increase the force which is necessary for removing the strip from the window frame.

14. The arrangement as claim in claim 7, in which the strip has an extension which forms at least part of the glass-panel-accommodating channel, a portion of the glass-panel-accommodating channel being removed by virtue of the abovementioned portion of the extruded material being removed.

15. The arrangement as claimed in claim 1, in which the part comprises a non-reinforced piece of formed harder material with a channel for accommodating the window panel and with an outer surface which is covered with a softer material, which is formed onto the harder material.

16. The arrangement as claimed in claim 15 and with a portion for retaining a first and a second window panel, the harder material having first and second, oppositely directed channels for accommodating respective window panels and having outer surfaces, between the channels, which are covered with a softer material, which is formed onto the harder material.

17. The arrangement as claimed in claim 16, in which the second channel bears a separate seal made of flexible material, the first window panel being accommodated in said seal.

18. The arrangement as claimed in claim 17, in which the seal has flocked panel-abutment surfaces.

19. The arrangement as claimed in claim 17, in which said second channel is generally U-shaped in cross section and said seal has a body of generally U-shaped cross section which is accommodated in the first channel.

20. The arrangement as claimed in claim 19, in which the seal has a base and a pair of flanges which project from respective opposite ends of said base and butt against the second channel in order to retain the seal in the second channel.

21. The arrangement as claimed in claim 19, in which the seal has two extensions which form the arms of said U-shaped cross section, each extension terminating in a respective flange which covers one end of an associated leg of the first channel.

22. The arrangement as claimed in claim 21, in which one of said extensions of the seal has at least one lip which projects to the inside of the seal of U-shaped cross section, said flange having a flocked surface for butting against the associated window pane.

23. The arrangement as claimed in claim 22, in which two lips are provided, on flange being located in the direction of the free end of the associated extension of the seal and the other flange being located in the direction of the base of the seal.

24. The arrangement as claimed in claim 22, in which the other extension of the seal has a flocked inner surface.

25. The arrangement as claimed in claim 1, in which the part has a portion in which the softer material is formed in order to provide at least one frame-engagement element running along the same.

26. The arrangement as claimed in claim 25, in which the frame-engagement element is a lip.

27. The arrangement as claimed in claim 25, in which the frame-engagement element is a recess.

28. The arrangement as claimed in claim 25, in which said harder material of said portion has a generally U-shaped cross section with a first extension and a second extension which are spaced apart from one another and connected to one another by a base, the channel being formed between said extensions and said softer material being formed around outer surfaces of said extensions and base.

29. The arrangement as claimed in claim 25, in which the hard material has a Shore hardness D of 40.

30. The arrangement as claimed in claim 25, in which the harder material is polypropylene.

31. The arrangement as claimed in claim 25, in which the softer material has a Shore hardness A of 60.

32. The arrangement as claimed in claim 25, in which the softer material is a thermoplastic material.

33. The arrangement as claimed in claim 1 in combination with a window panel accommodated in the strip.

34. The arrangement as claimed in claim 1, in which the window panel is a motor-vehicle window panel.

35. The arrangement as claimed in claim 34, in which the window panel is a door-mounted quarter-window panel.

36. A motor vehicle comprising an arrangement which is intended for mounting a sealing, trimming or guide strip in relation to a window panel and has a part which is fitted on the window panel and has means for connecting the strip mechanically to the part.

37. A method of mounting a sealing, trimming or guide strip in relation to a window panel, the method providing for fitting a part on the window panel and for connecting the strip mechanically to the part.

38-40. (canceled)
